(19) United States
(12) Patent Application Publication
(10) Pub. No.: US 2004/0021333 A1
(43) Pub. Date: Feb. 5, 2004

(54) Top/blind for ATVs

(76) Inventor: Johnny C. Hancock, Star, NC (US)

Correspondence Address: Richard C. Litman, LITMAN LAW OFFICES, LTD., P.O. Box 15035, Arlington, VA, 22215, US

(21) Appl. No.: 10/630,850

(22) Filed: Jul. 31, 2003

Related U.S. Application Data
(60) Provisional application No. 60/400,040, filed on Aug. 2, 2002.

(51) Int. Cl. B60J 7/00

(52) U.S. Cl. 296/79

(57) ABSTRACT

A top or blind to attach to an ATV, to protect a user from the weather or inclement conditions. This top may also be used as a stand-alone shelter or hunting blind. Made of nylon, which may be camouflage-colored, it includes a case with two flexible rods that form an arch. There are several cross rods imbedded in the cover. The cross rods, cover, side curtains and flexible rods are normally contained in the case. The case is releasably attached to an ATV and when the flexible rods are assembled, they can be fixed to the front of the ATV forming the arch to which the side curtains are releasably attached.

### CROSS-REFERENCE TO RELATED APPLICATION

This application claims the benefit of U.S. Provisional Patent Application Serial No. 60/400,040, filed Aug. 2, 2002.

### BACKGROUND OF THE INVENTION

1. Field of the Invention

The present invention relates to vehicle covers and particularly to a top or blind that is releasably secured to an All Terrain Vehicle (ATV) to form a protective arch over the vehicle.

2. Description of the Related Art

There are several varied constructions that have been attached to vehicles, some of them being the sporty and fun ATVs that have forged a market familiar to off-road enthusiasts everywhere. None of the known constructions, however, have the flexibility, efficiency and ease of erection that the instant invention provides.

U.S. Pat. No. 5,458,390 to Gilbert for a “Soft Top” provides a cover for a motorcycle but lacks many features of the instant invention.

U.S. Publication No. 2001/0035666 A1 to Allen for a “Portable Enclosure”, U.S. Pat. No. 6,105,721 to Haynes for an “Accessory for Use With an ATV”, U.S. Pat. No. 5,297,844 to Haustein for a “Removable Cab and Stand for All Terrain Vehicles”, U.S. Pat. No. 4,973,082 to Kincheloe for a “Roll Cage for Personal Vehicles” and U.S. Pat. No. 4,950,017 to Norton for a “Kit Which Provides a Removable Top Assembly For All-Terrain Vehicles and the Like, and the Assembled Top Thereof” all disclose a top or enclosure for an ATV yet lack one or more features of the instant invention.

U.S. Pat. No. 4,533,170 to Banks et al. for a “Stroller Cover and Support Frame Therefor” discloses an arcuate flexible frame attached to a child's stroller.

U.S. Pat. No. 5,378,035 to Wu for an “Automobile Sunshade” and U.S. Pat. No. 5,022,700 to Fasiska et al. for a “Mounting System for and Automobile Cover” disclose rolled covers for automobiles in cases at the rear of the autos.

None of the above inventions and patents, taken either singly or in combination, is seen to describe the instant invention as claimed. Thus a top/blind for ATVs solving the aforementioned problems is desired.

### SUMMARY OF THE INVENTION

The invention is a top or blind that attaches to an ATV, to protect a user from the weather or inclement conditions or for use as a hunting blind. These tops may be used as a stand-alone shelter or a ground hunting blind. Preferably, they are made of nylon, which may be camouflage colored. The tops are assembled with two flexible rods that form an arch. There are several cross rods imbedded in the cover, the cross rods and cover being normally contained in the case. The case is releasably attached to an ATV and when the flexible rods are assembled, they can be fixed to the front of the ATV forming the arch to which side curtains are releasably attached.

Accordingly, it is a principal object of the invention to provide a flexible and lightweight overhead cover for use as a top or a blind with an ATV.

It is another object of the invention to make the cover portable.

It is a further object of the invention to provide a carrying case that all elements of the cover will fit into when the cover is not assembled.

Still another object of the invention is to provide pockets in the cover for various uses by the drivers of the ATV's.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a side view of a top/blind on an ATV according to the present invention.

FIG. 2 is a front view of the invention on an ATV.

FIG. 3 is a side view of the detachable side curtains.

FIG. 4 is a view of one of the flexible rods broken down.

Similar reference characters denote corresponding features consistently throughout the attached drawings.

### DETAILED DESCRIPTION OF THE PREFERRED EMBODIMENTS

The present invention is an overhead cover for a user of an ATV. It may be mounted on the ATV or be free standing. It is very lightweight and easily erected in order to enable a user to continue in the out of doors despite a localized shower or other inclement weather and continue off-roading after the weather passes.

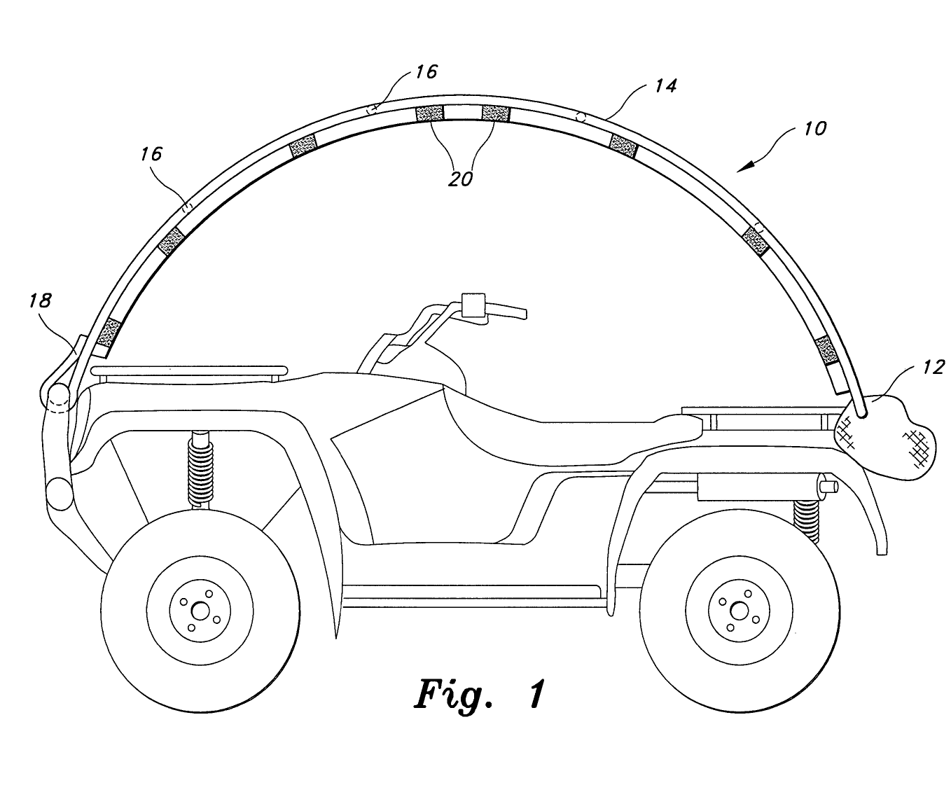

Shown in FIG. 1 is an ATV of the four-wheel type, and mounted upon this ATV is the cover 10. The cover 10 extends from a carrying case 12 that is mounted to the ATV by any appropriate mechanism such as straps, clips or even placed in a carry all structure on the rear of the ATV. Though the carrying case 12 is depicted as soft or fabric, the case may also be made of a rigid plastic material such as PVC or other hard plastic.

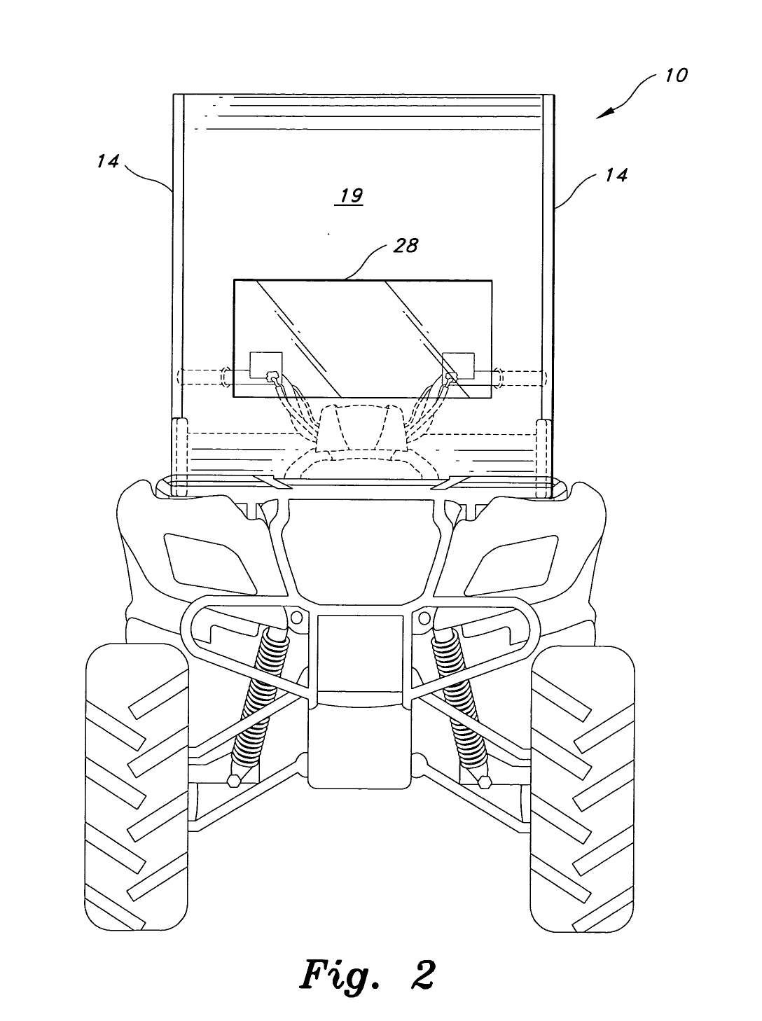

The cover 10 has side arches 14 that are made up of flexible and collapsible rods. The side arches 14 are attached to the carrying case 12 on one end, and attached to the structure of the ATV at the other end by loops 18 which are normally mounted to the cover 10 itself. The cover 10 is made of fabric 19 (FIG. 2), preferably nylon. Several cross supports 16 are attached to the fabric. They may be attached by clips, hooks, fabric fasteners or in sewn in pockets in the fabric material itself.

Toward the front of the vehicle is a window 28 as seen in FIG. 2, which is made of transparent plastic in order to enable a user to drive with the invention in place on the ATV, if necessary. The cover 10 and window 28 are flexible enough to place into the carrying bag 12 when not deployed. Not shown are pockets under the window 28 for use as the user sees fit for such things as binoculars, ammunition, bottles, etc.

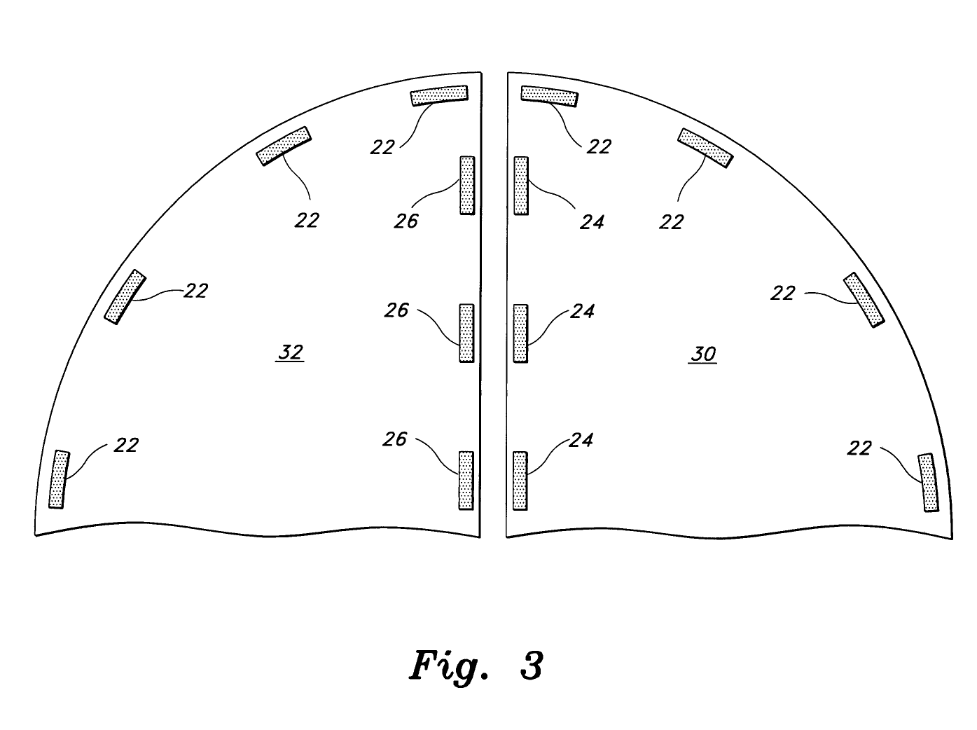

One set of side curtains 30 and 32, are shown in FIG. 3. One set of side curtains is located on each side of the ATV and each set comprises two pieces 30 and 32. These side curtains are made of flexible material for folding and storage and may be made of transparent material or have a transparent window (not shown) such as the front window 28. The side curtains have numerous patches of fasteners 22, 24 and 26 for mounting and closing. The cover 10 has a plurality of patches of matching fastener material 20 which mate with the fasteners 22 on the side curtains holding them assembled in the arch. Closure is obtained by attaching fasteners 24 and mating fasteners 26. The fasteners 20,22,24 and 26 may comprise any suitable type of fastener including, but not limited to, hook/loop fasters, fabric fasteners and zippers.

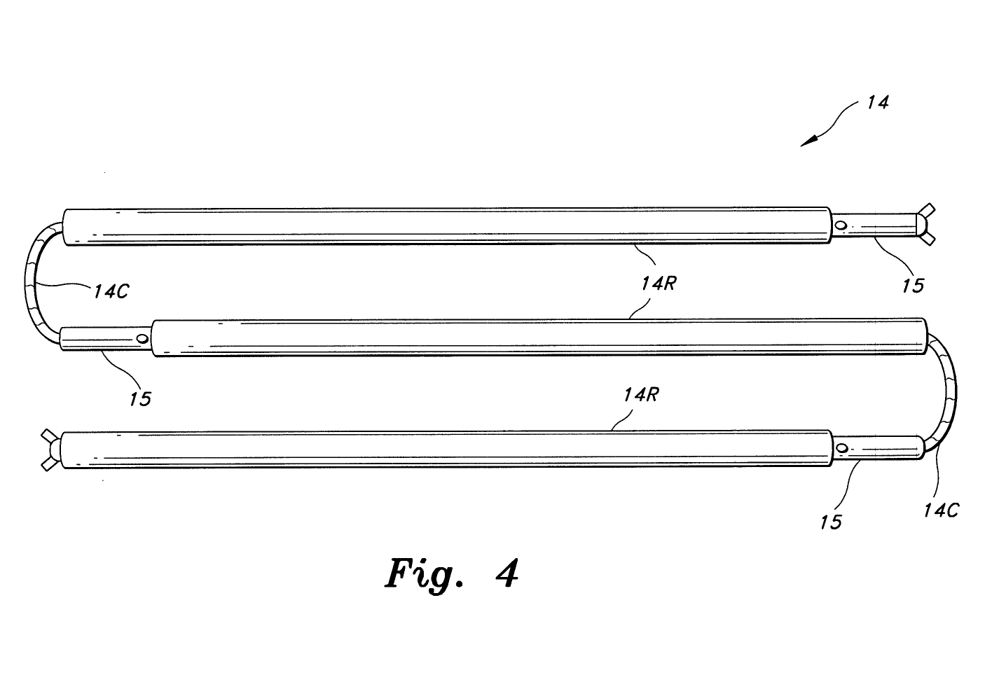

One example of the flexible rods 14 is seen in FIG. 4. Rod 14 is made up of three sections 14R. More sections, e.g., four or even five, may be used to facilitate carrying in the carry case. Each section 14R is attached to its adjacent section by a shock cord 14C, which is elastic in nature and of sufficient length as to extend the entire length of the flexible rod. Each section has a rigid section 15 which is sized to be placed into a hollow end segment of the adjacent section in a telescoping fashion. As is widely known in modern tents for campers, these rods are made of fiberglass and resin, or other plastics. They are light weight but sturdy. Though somewhat rigid they are also flexible.

There are a myriad of uses for the invention. For example, if inclement weather is experienced, the driver of the ATV can erect the structure over the ATV, and wait out a storm, by pulling out the collapsed flexible rods and assembling them, pulling out the side curtains and then extending the cover fabric. Attaching the flexible rods at the sides of the cover fabric and then attaching to the front structures of the ATV creates the arch. Attaching the side curtains then encloses a space for an occupant or driver. For the sake of safety, however, it is not recommended that the ATV be driven while the cover is up.

Alternate uses of the cover include as a stand alone tent with the flexible rods being butted against a rock, mound of earth, tree or even the ATV itself. It is envisioned that a strap may be constructed to extend from one end of the flexible rod to the other to enable formation of the arch and hold the rods in their arched shape. These alternate uses allow a user to form a hunting blind, which is especially useful if the nylon, or other, fabric of the cover is colored in a camouflage pattern. It should also be apparent that these covers could act as an emergency shelter for one or two persons.

It is to be understood that the present invention is not limited to the embodiments described above, but encompasses any and all embodiments within the scope of the following claims.

I claim:

1. A cover for a vehicle, comprising
a carrying case for transporting portions of said cover, said carrying case having quick-disconnect mounting mechanisms for mounting the cover to the vehicle;
a flexible fabric main body attached to said carrying case at a first end, said fabric main body having attachment mechanisms attached to the vehicle at an end distal from said carrying case, said fabric main body forming an arcuate shelter;
a plurality of flexible and collapsible rods, one of said rods disposed at each side of said flexible fabric main body, said rods being assembled and attached to said flexible fabric main body and providing support for said cover; and
side curtains attached to said flexible fabric cover adjacent each of said flexible rods providing access under said cover.

2. The cover for a vehicle according to claim 1, further comprising at least one transparent window disposed along said flexible fabric main body for observation through said cover.

3. The cover for a vehicle according to claim 1, wherein said mounting mechanisms are selected from the group consisting of straps, clips and carry all structures.

4. The cover for a vehicle according to claim 1, wherein said carrying case is made from a material selected from the group consisting of fabric, PVC and hard plastics.

5. The cover for a vehicle according to claim 1, wherein said rods are attached to the carrying case at a first end and are attached to the structure of the vehicle at a second end by loops that are mounted to the flexible fabric main body.

6. The cover for a vehicle according to claim 1, wherein said flexible fabric main body is made from nylon.

7. The cover for a vehicle according to claim 1, further comprising a plurality of cross supports secured to said flexible fabric main body.

8. The cover according to claim 7, wherein said cross supports are secured to said flexible fabric main body by a fastener selected from the group consisting of clips, hooks, fabric fasteners and sewn in pockets.

9. The cover according to claim 1, wherein said side curtains comprise a pair of side curtain portions disposed on both sides of said vehicle.

10. The cover according to claim 1, further comprising a plurality of curtain fasteners disposed along said flexible fabric main body.

11. The cover according to claim 10, wherein said side curtains further comprise a plurality of curtain mounts for releasably engaging said curtain fasteners for releasably securing said side curtains to the flexible fabric main body.

12. The cover according to claim 11, wherein said curtain fasteners and said curtain mounts are selected from the group consisting of fabric fasteners, hook and loop fasteners and zippers.

13. The cover according to claim 1, wherein said rods further comprise:
a plurality of hollow, cylindrical interconnectable sections having a first end and a hollow second end;
a generally elastic shock cord extending through the interconnectable sections, wherein said shock cord connects said sections; and
a plurality of rigid fasteners disposed on the first end of each of said sections, the fasteners being placed in to the hollow second end of an adjacent section to form a rod.

14. The cover according to claim 13, wherein said rods each comprise three interconnectable sections.
